(19) United States
(12) Patent Application Publication
(10) Pub. No.: US 2014/0335742 A1
(43) Pub. Date: Nov. 13, 2014

(54) Seth's quick release battery cables

(71) Applicant: Roger Alan Connell, China Grove, NC (US)

(72) Inventor: Roger Alan Connell, China Grove, NC (US)

(21) Appl. No.: 13/891,033

(22) Filed: May 9, 2013

(51) Int. Cl. H01R 11/22

(52) U.S. Cl. CPC H01R 11/22
USPC 439/759

(57) ABSTRACT

A better way to change a dead battery.

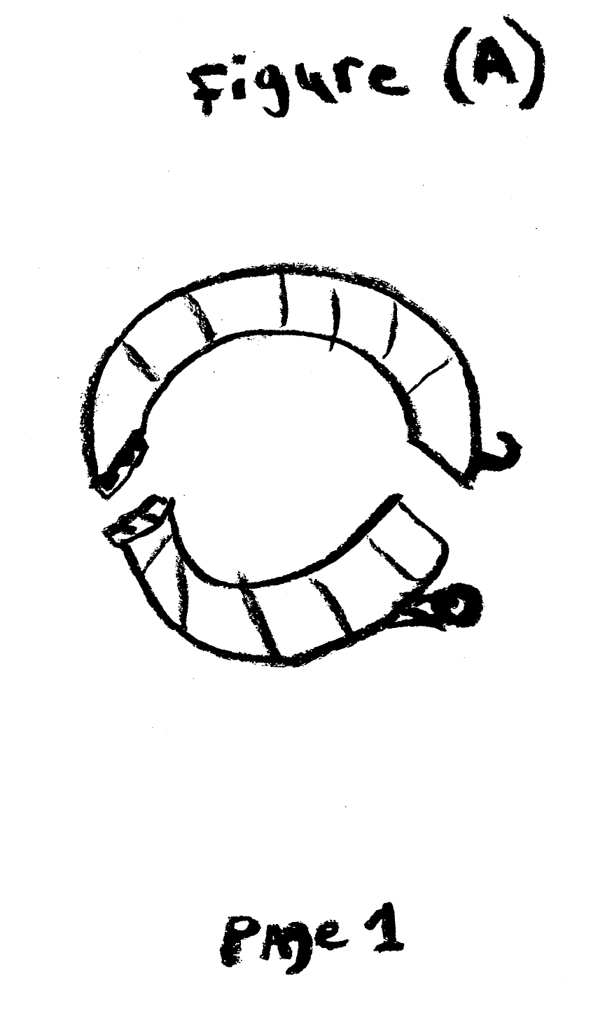

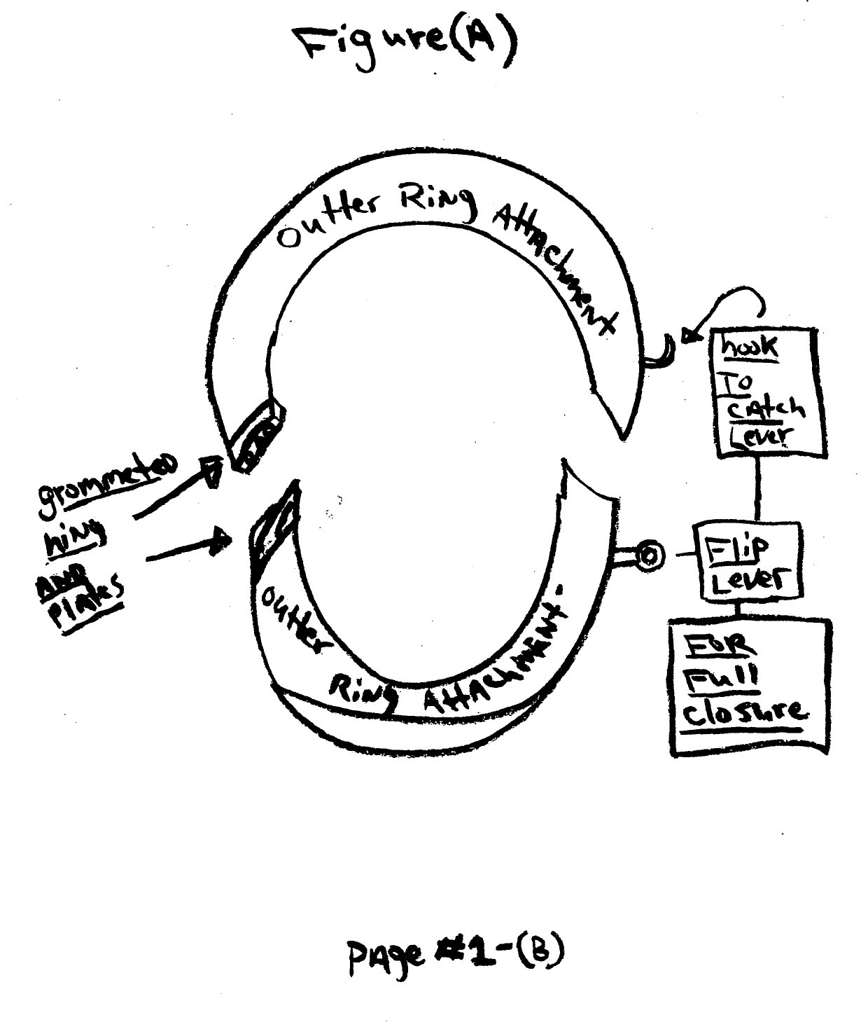

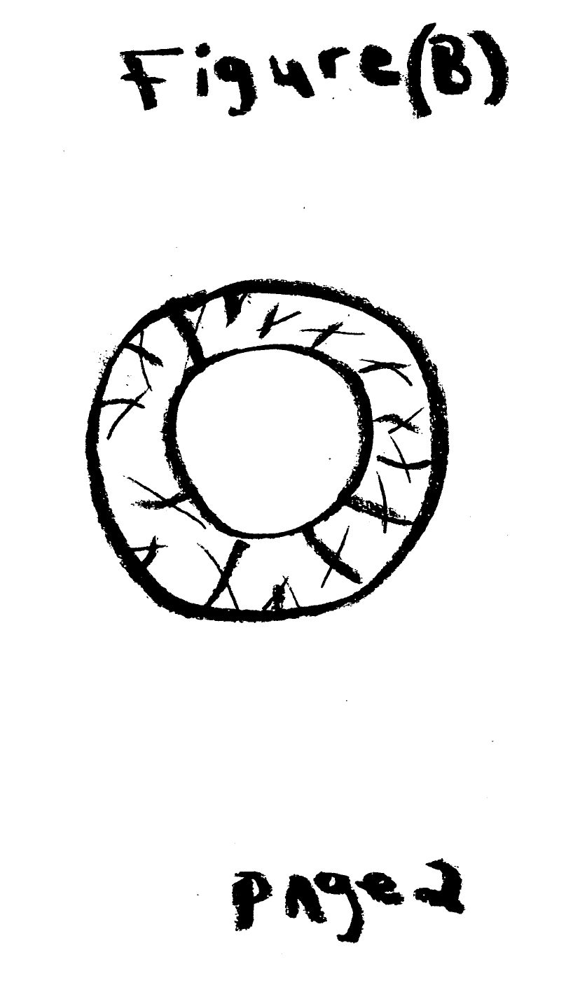

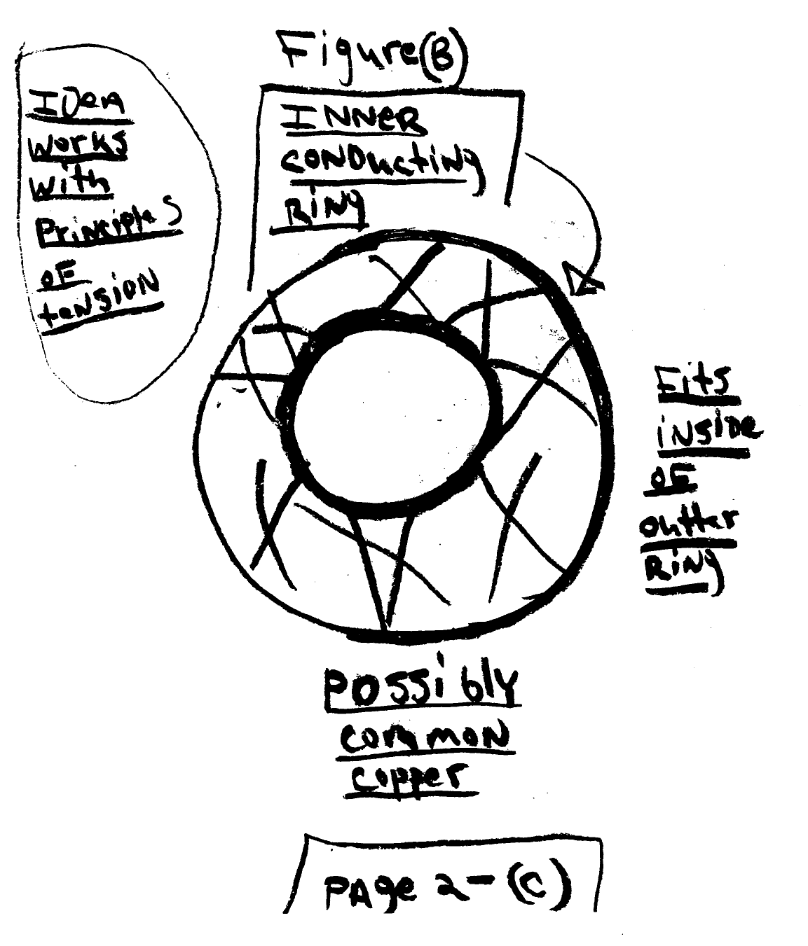

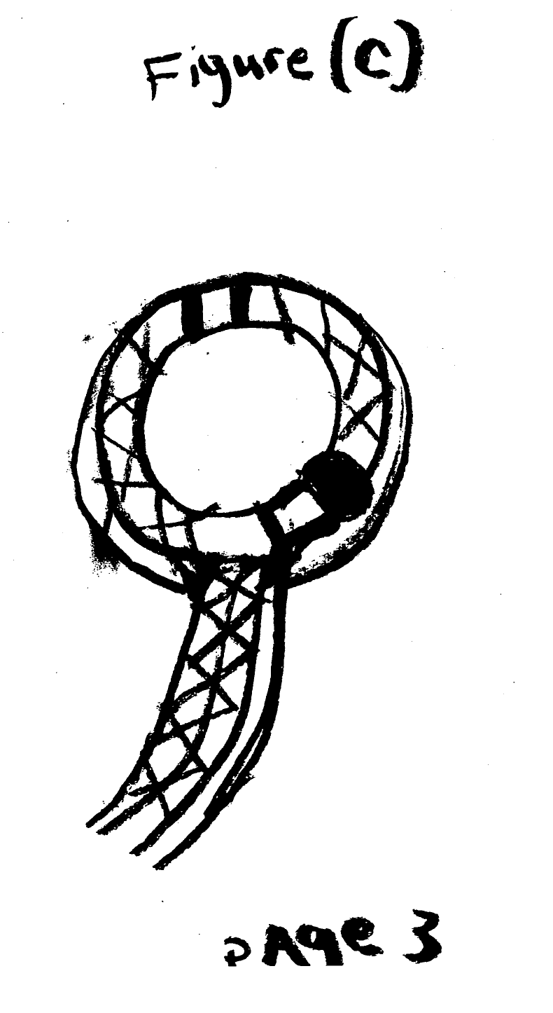

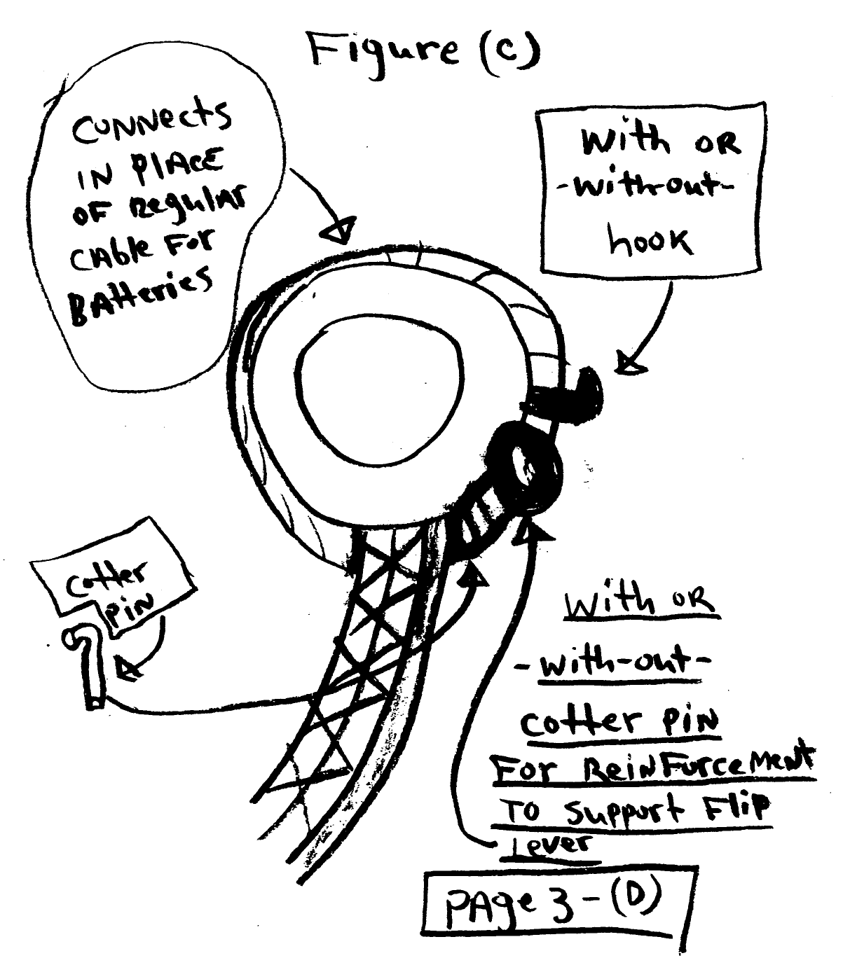

Brief description of the several views of the drawings as required by: 37 CFR 1.74 and, 37 CFR 1.77 (b) (7).

### BRIEF DESCRIPTION OF SEVERAL VIEWS

On page #1, Figure (A): is the outer part or connecting ring, of “Seth's Quick Release Battery Cables”, without a cotter pin reinforcement attachment. Which also shows 2 such integral parts of the invention: 1—the locking flip lever, and 2—heavy duty hinged end; which is intended to be made to fit upon all standards of battery posts: cars, motor bikes, atvs, motor homes and etc . . .

On page #2, Figure (B): is an example of what the inner core ring might look like and be made from. Which is also referred to as the (INNER CONDUCTING RING). This may be made of copper; a common standard in conducting metals.

On page #3, Figure (C): This is another view of the invention, with more of it's cable, and another diagram, showing the (GROMETTED HINGE PLATE) and (LOCKING FLIP LEVER). Note the only difference is the cotter pin attachment alternate method, to be used as a reinforcement to the locking flip lever.

NOTE: cotter pin may now be drawn upon a separate page; page #4, and such like.

Further note: Page #4, of the original submission is now of no consequence; as I've already explained in the above transmission.

1. My claim is quite simple; and it is this, “Seth's Quick Release Battery Cables” will revolutionize the industry and the way we handle a dead battery in the freezing cold of winter, or the dead heat of summer. This will mean a few less cuts and far less hassle. It is a gold mine waiting to happen and to put it into terms of the American way of thinking; a gem of ingenuity and simplistic elegance.
